(19) United States
(12) Patent Application Publication
(10) Pub. No.: US 2017/0366448 A1
(43) Pub. Date: Dec. 21, 2017

(54) GENERATING AND TRANSMITTING BACK-TO-SOURCE ROUTING INFORMATION

(71) Applicant: Alibaba Group Holding Limited, Grand Cayman (KY)

(72) Inventor: JingYuan Hei, Hangzhou (CN)

(73) Assignee: Alibaba Group Holding Limited

(21) Appl. No.: 15/622,618

(22) Filed: Jun. 14, 2017

(30) Foreign Application Priority Data
Jun. 16, 2016 (CN) 201610425989.X

(51) Int. Cl. H04L 12/733; H04L 12/26; H04L 29/08

(52) U.S. Cl. CPC H04L 45/20; H04L 67/2842; H04L 43/08; H04L 67/10

(57) ABSTRACT

A method including acquiring, by a first CDN cache server, a first network distance, a second network distance and a third network distance; determining, by the first CDN cache server, that the first network distance is greater than the sum of the second network distance and the third network distance, generating back-to-source routing information, and sending the back-to-source routing information to a second CDN cache server; a back-to-source routing path indicated by the back-to-source routing information including: passing through the first CDN cache server, the second CDN cache server and a source station. The techniques of the present disclosure employ an indirect back-to-source route when determining, according to a network distance between the source station and the CDN cache server, that a back-to-source route of indirect back-to-source is better than that of direct back-to-source, thus increasing a back-to-source speed and reducing a back-to-source error rate.

### CROSS REFERENCE TO RELATED PATENT APPLICATIONS

This application claims priority to Chinese Patent Application No. 201610425989.X, filed on Jun. 16, 2016, entitled “METHOD AND APPARATUS FOR GENERATING AND TRANSMITTING BACK-TO-SOURCE ROUTING INFORMATION,” which is hereby incorporated by reference in its entirety.

### TECHNICAL FIELD

The present disclosure relates to the field of Internet technologies and, in particular, to a method and apparatus for generating and transmitting back-to-source routing information.

### BACKGROUND

A Content Delivery Network (CDN) technology can achieve the aim of speeding up access by setting a CDN cache server between a user equipment and a source station.

An access process that uses the CDN technology includes: sending, by a user equipment, an access request to a CDN cache server, the access request indicating a network resource required by the user equipment; if the CDN cache server caches the network resource, returning the network resource directly to the user equipment; and if the CDN cache server does not cache the network resource, acquiring the network resource from a source station, and caching the network resource acquired from the source station to the CDN cache server and then returning the network resource to the user equipment.

The process of acquiring, by the CDN cache server, the network resource from the source station is referred to as a CDN back-to-source process. Conventionally, a direct back-to-source manner is generally employed in the CDN back-to-source process, that is, a back-to-source routing path is from the CDN cache server directly to the source station, and the CDN cache server sends to the source station back-to-source routing information indicating the back-to-source routing path, and acquires the network resource directly from the source station.

However, as the source station is not an internal device of a CDN system, problems such as a relatively poor network condition and a relatively long transmission distance may exist between the source station and the CDN cache server, and such a direct back-to-source manner is likely to lead to a relatively slow back-to-source speed and even back-to-source failure.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

A technical problem to be solved by the present disclosure is to provide a back-to-source routing information generation, transmission method and related apparatuses, to achieve determination of an optimal back-to-source routing path according to a network distance between a source station and a CDN cache server, thus increasing a back-to-source speed and reducing a back-to-source error rate.

To this end, the technical solution for solving the technical problem of the present disclosure is as follows:

The present disclosure provides a back-to-source routing information generation method, for use in a back-to-source process of a CDN, the generation method including:

acquiring, by a first CDN cache server, a first network distance, a second network distance and a third network distance, wherein the first network distance is a direct network distance between the first CDN cache server and a source station, the second network distance is a direct network distance between the first CDN cache server and a second CDN cache server, and the third network distance is a direct or indirect network distance between the second CDN cache server and the source station;

determining, by the first CDN cache server, that the first network distance is greater than the sum of the second network distance and the third network distance; and

generating, by the first CDN cache server, back-to-source routing information and sending the back-to-source routing information to the second CDN cache server; a back-to-source routing path indicated by the back-to-source routing information including: passing through the first CDN cache server, the second CDN cache server and the source station.

Optionally, the acquiring, by the first CDN cache server, the first network distance and a second network distance includes detecting, by the first CDN cache server, the first network distance and the second network distance; and

the acquiring, by the first CDN cache server, the third network distance includes acquiring, by the first CDN cache server, the third network distance sent by the second CDN cache server.

Optionally, the CDN has multiple levels of cache nodes, wherein the top-level cache node is used for acquiring network resources directly from the source station; and

the first CDN cache server and the second CDN cache server both belong to the top-level cache node.

Optionally, the third network distance is an indirect network distance between the second CDN cache server and the source station, the third network distance is a sum of a fourth network distance and a fifth network distance, the fourth network distance is a direct network distance between the second CDN cache server and a third CDN cache server, and the fifth network distance is a direct or indirect network distance between the third CDN cache server and the source station; and

the back-to-source routing path indicated by the back-to-source routing information includes: passing through the first CDN cache server, the second CDN cache server, the third CDN cache server and the source station.

Optionally, the first network distance, the second network distance or the third network distance is calculated according to any one or more of the following parameters:

connection setup time, a physical transmission distance, a transmission bandwidth, and transmission quality.

The present disclosure provides a back-to-source routing information transmission method, for use in a back-to-source process of a CDN, the transmission method including:

receiving, by a second CDN cache server, back-to-source routing information sent by a first CDN cache server, a back-to-source routing path indicated by the back-to-source routing information including: passing through the first CDN cache server, the second CDN cache server and a source station; and

sending, by the second CDN cache server, the back-to-source routing information to the source station,

wherein the first network distance is greater than the sum of the second network distance and the third network distance, the first network distance is a direct network distance between the first CDN cache server and the source station, the second network distance is a direct network distance between the first CDN cache server and the second CDN cache server, and the third network distance is a direct or indirect network distance between the second CDN cache server and the source station.

Optionally, before the back-to-source routing information is received, the transmission method further includes:

detecting, by the second CDN cache server, the third network distance; and

sending, by the second CDN cache server, the detected third network distance to the first CDN cache server.

Optionally, the CDN has multiple levels of cache nodes, wherein the top-level cache node is used for acquiring network resources directly from the source station; and

the first CDN cache server and the second CDN cache server both belong to the top-level cache node.

Optionally, the third network distance is an indirect network distance between the second CDN cache server and the source station, the third network distance is the sum of the fourth network distance and the fifth network distance, the fourth network distance is a direct network distance between the second CDN cache server and the third CDN cache server, and the fifth network distance is a direct or indirect network distance between the third CDN cache server and the source station;

the back-to-source routing path indicated by the back-to-source routing information includes: passing through the first CDN cache server, the second CDN cache server, the third CDN cache server and the source station; and

the sending, by the second CDN cache server, the back-to-source routing information to the source station includes sending, by the second CDN cache server, the back-to-source routing information to the source station through the third CDN cache server.

Optionally, the first network distance, the second network distance or the third network distance is calculated according to any one or more of the following parameters:

connection setup time, a physical transmission distance, a transmission bandwidth, and transmission quality.

The present disclosure provides a CDN cache server, the CDN cache server being a first CDN cache server, the first CDN cache server including:

an acquisition unit configured to acquire a first network distance, a second network distance and a third network distance, wherein the first network distance is a direct network distance between the first CDN cache server and a source station, the second network distance is a direct network distance between the first CDN cache server and a second CDN cache server, and the third network distance is a direct or indirect network distance between the second CDN cache server and the source station;

a determination unit configured to determine that the first network distance is greater than the sum of the second network distance and the third network distance;

a generation unit configured to generate back-to-source routing information after the determination unit determines that the first network distance is greater than the sum of the second network distance and the third network distance; and a sending unit configured to send the back-to-source routing information to the second CDN cache server; a back-to-source routing path indicated by the back-to-source routing information including: passing through the first CDN cache server, the second CDN cache server and the source station.

Optionally, the acquisition unit includes:

a detection sub-unit configured to detect the first network distance and the second network distance; and

an acquisition sub-unit configured to acquire the third network distance sent by the second CDN cache server.

Optionally, a CDN has multiple levels of cache nodes, wherein the top-level cache node is used for acquiring network resources directly from the source station; and

the first CDN cache server and the second CDN cache server both belong to the top-level cache node.

Optionally, the third network distance is an indirect network distance between the second CDN cache server and the source station, the third network distance is the sum of a fourth network distance and a fifth network distance, the fourth network distance is a direct network distance between the second CDN cache server and a third CDN cache server, and the fifth network distance is a direct or indirect network distance between the third CDN cache server and the source station; and

the back-to-source routing path indicated by the back-to-source routing information includes: passing through the first CDN cache server, the second CDN cache server, the third CDN cache server and the source station.

Optionally, the first network distance, the second network distance or the third network distance is calculated according to any one or more of the following parameters:

connection setup time, a physical transmission distance, a transmission bandwidth, and transmission quality.

The present disclosure provides a CDN cache server, the CDN cache server being a second CDN cache server, the second CDN cache server including:

a receiving unit configured to receive back-to-source routing information sent by a first CDN cache server, a back-to-source routing path indicated by the back-to-source routing information including: passing through the first CDN cache server, the second CDN cache server and a source station; and

a sending unit configured to send the back-to-source routing information to the source station;

wherein a first network distance is greater than the sum of a second network distance and a third network distance, the first network distance is a direct network distance between the first CDN cache server and the source station, the second network distance is a direct network distance between the first CDN cache server and the second CDN cache server, and the third network distance is a direct or indirect network distance between the second CDN cache server and the source station.

Optionally, the second CDN cache server further includes:

a detection unit configured to detect the third network distance by the second CDN cache server; and

the sending unit is further configured to send the detected third network distance to the first CDN cache server.

Optionally, a CDN has multiple levels of cache nodes, wherein the top-level cache node is used for acquiring network resources directly from the source station; and the first CDN cache server and the second CDN cache server both belong to the top-level cache node.

Optionally, the third network distance is an indirect network distance between the second CDN cache server and the source station, the third network distance is the sum of a fourth network distance and a fifth network distance, the fourth network distance is a direct network distance between the second CDN cache server and a third CDN cache server, and the fifth network distance is a direct or indirect network distance between the third CDN cache server and the source station;

the back-to-source routing path indicated by the back-to-source routing information includes: passing through the first CDN cache server, the second CDN cache server, the third CDN cache server and the source station; and

the sending unit is specifically configured to send the back-to-source routing information to the source station through the third CDN cache server.

Optionally, the first network distance, the second network distance or the third network distance is calculated according to any one or more of the following parameters:

connection setup time, a physical transmission distance, a transmission bandwidth, and transmission quality.

The present disclosure provides a CDN system, including a first CDN cache server, a second CDN cache server and a source station. The first CDN cache server is configured to acquire a first network distance, a second network distance and a third network distance, determine that the first network distance is greater than the sum of the second network distance and the third network distance, generate back-to-source routing information, and send the back-to-source routing information to the second CDN cache server. The first network distance is a direct network distance between the first CDN cache server and the source station, the second network distance is a direct network distance between the first CDN cache server and the second CDN cache server, and the third network distance is a direct or indirect network distance between the second CDN cache server and the source station. A back-to-source routing path indicated by the back-to-source routing information including: passing through the first CDN cache server, the second CDN cache server and the source station.

The second CDN cache server is configured to receive the back-to-source routing information sent by the first CDN cache server, and send the back-to-source routing information to the source station.

The source station is configured to receive the back-to-source routing information sent by the second CDN cache server, and return a network resource according to a reverse direction of a path indicated by the back-to-source routing path.

As shown through the above technical solution, the example embodiments of the present disclosure are used in a back-to-source process of a CDN and a first CDN cache server no longer employs a direct back-to-source manner. Instead, when it is determined that a first network distance is greater than the sum of a second network distance and a third network distance, that is, a direct network distance between the first CDN cache server and a source station is greater than an indirect network distance (a network distance from the first CDN cache server to the source station through a second CDN cache server), which indicates that a back-to-source routing path of indirect back-to-source is better than that of direct back-to-source, back-to-source routing information indicating the indirect back-to-source is generated, and the back-to-source routing information is sent to the second CDN cache server to implement indirect back-to-source. Thus, the example embodiments of the present disclosure may employ an indirect back-to-source route when determining, according to a network distance between the source station and the CDN cache servers, that the indirect back-to-source route is better than the direct back-to-source route, there increasing a back-to-source speed and reducing a back-to-source error rate.

### BRIEF DESCRIPTION OF THE DRAWINGS

In order to describe the technical solutions in the example embodiments of the present disclosure clearly, the accompanying drawings to be used in the description of the example embodiments are briefly introduced in the following. It is apparent that the accompanying drawings in the following description merely represent some of the example embodiments of the present disclosure, and those of ordinary skill in the art may also obtain other drawings according to the accompanying drawings.

FIG. 1 is a schematic flowchart of an example method embodiment of a generation method according to the present disclosure;

FIG. 2 is a schematic structural diagram of an example system embodiment of a CDN system according to the present disclosure;

FIG. 3 is a schematic structural diagram of another CDN according to the present disclosure;

FIG. 4 is a schematic flowchart of an example method embodiment of a transmission method according to the present disclosure;

FIG. 5 is a schematic flowchart of another example method embodiment of a generation and transmission method according to the present disclosure;

FIG. 6 is a schematic structural diagram of an example apparatus embodiment of a CDN cache server according to the present disclosure; and

FIG. 7 is a schematic structural diagram of another example apparatus embodiment of the CDN cache server according to the present disclosure.

### DETAILED DESCRIPTION

In a conventional access process, a user equipment directly accesses a source station to acquire, from the source station, a desired network resource. The CDN technology is to speed up the conventional access process. In an access process that uses the CDN technology, a user equipment sends an access request to a CDN cache server, and the access request indicates a network resource required by the user equipment. If the CDN cache server caches the network resource, the network resource is returned directly to the user equipment. If the CDN cache server does not cache the network resource, a back-to-source process of the CDN is performed, that is, the CDN cache server acquires the network resource from a source station, and the network resource is cached to the CDN cache server and returned to the user equipment.

At present, a direct back-to-source manner is generally employed in the CDN back-to-source process. The CDN cache server generates back-to-source routing information. A back-to-source routing path indicated by the back-to-source routing information is from the CDN cache server directly to the source station. The CDN cache server sends the back-to-source routing information to the source station, and the source station, after receiving the back-to-source routing information, returns a network resource directly to the CDN cache server. However, as the source station is not an internal device of a CDN system, problems such as a relatively poor network condition and a relatively long transmission distance may exist between the source station and the CDN cache server. In addition, such a direct back-to-source manner is likely to lead to a relatively slow back-to-source speed and even back-to-source failure.

The technical problem to be solved in the example embodiments of the present disclosure is to provide a back-to-source routing information generation, transmission method and related apparatuses to achieve determination of a better back-to-source routing path according to a network distance between a source station and a CDN cache server. Thus, the technical solutions of the present disclosure increase a back-to-source speed and reduce a back-to-source error rate.

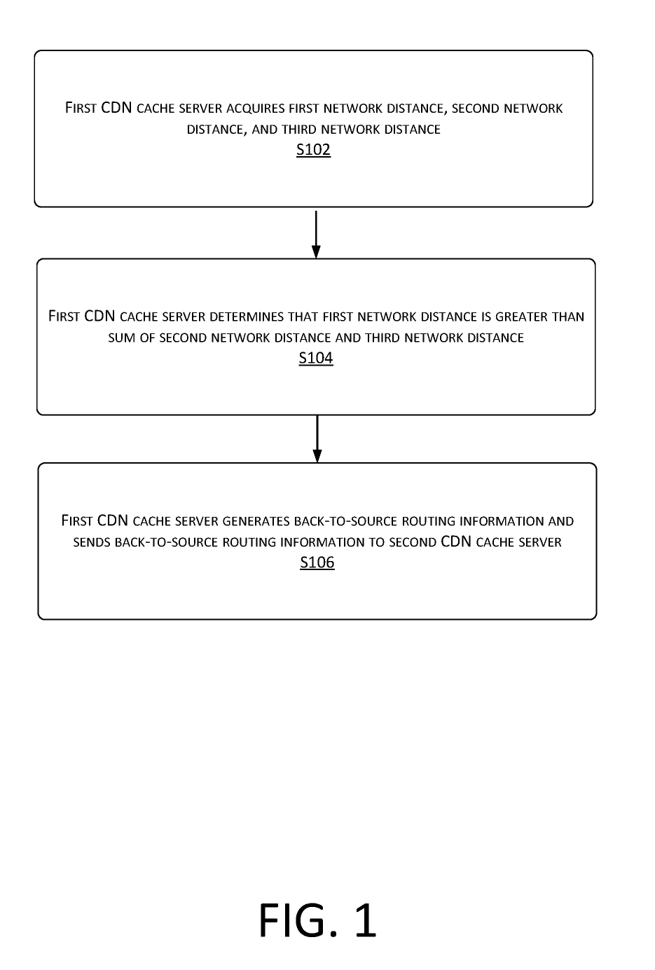

Referring to FIG. 1, an example embodiment of the present disclosure provides an example method embodiment of a back-to-source routing information generation method.

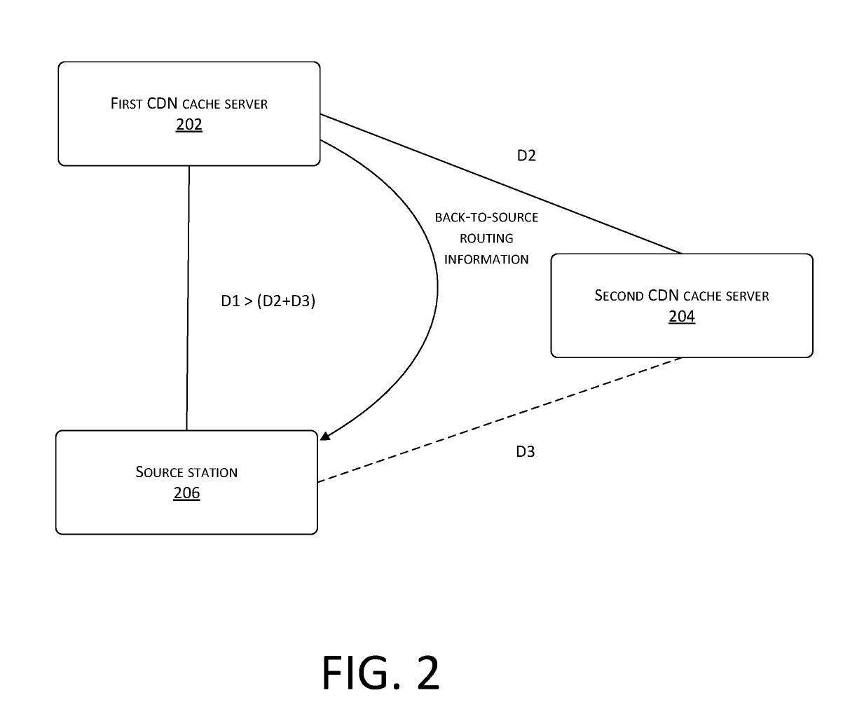

A CDN of this example embodiment may, as shown in FIG. 2, include a first CDN cache server 202, a second CDN cache server 204 and a source station 206, wherein the first CDN cache server 202 is directly connected to the source station 206, the first CDN cache server 202 is directly connected to the second CDN cache server 204, and the second CDN cache server 204 is directly or indirectly connected to the source station 206. In the example embodiment of the present disclosure, direct connection refers to that a connection link does not include another CDN cache server. For example, in FIG. 2, the first CDN cache server 202 and the source station 206 are connected without using a CDN cache server, while the second CDN cache server 204 and the source station 206 may be connected through another CDN cache server, for example, a third CDN cache server.

This example embodiment is applied to a back-to-source process of the CDN, that is, when the first CDN cache server 202 does not store a network resource requested by a user, at this point, the first CDN cache server 202 needs to acquire the network resource from the source station 206.

The generation method of this example embodiment includes:

S102: The first CDN cache server 202 acquires a first network distance D1, a second network distance D2 and a third network distance D3.

Wherein, the first network distance D1 is a direct network distance between the first CDN cache server 202 and the source station 206, the second network distance D2 is a direct network distance between the first CDN cache server 202 and the second CDN cache server 204, and the third network distance D3 is a direct or indirect network distance between the second CDN cache server 204 and the source station 206. The direct network distance refers to a network distance during direct transmission. For example, the first network distance D1 refers to a network distance during direct transmission between the first CDN cache server 202 and the source station 206. The indirect network distance refers to a network distance during indirect transmission. For example, the third network distance D3 may refer to a network distance during transmission between the second CDN cache server 204 and the source station 206 through another CDN cache server.

In the example embodiment of the present disclosure, the network distance is used for reflecting a network transmission speed of two nodes, and a smaller network distance indicates a faster network transmission speed. Wherein, the first network distance D1, the second network distance D2 or the third network distance D3 may be calculated according to any one or more of the following parameters: connection setup time, a physical transmission distance, a transmission bandwidth, and transmission quality.

In the example embodiment of the present disclosure, the first CDN cache server 202 may detect, in real time, the first network distance D1 between the first CDN cache server 202 and the second CDN cache server 204, and the second network distance D2 between the first CDN cache server 202 and the source station 206. For example, the time when a connection is set up between the first CDN cache server 202 and the second CDN cache server 204 is detected in real time, and the first network distance D1 is calculated according to the time. The second CDN cache server 204 may also detect, in real time, the third network distance D3 from the second CDN cache server 204 to the source station 206, and send the detected third network distance D3 to the first CDN cache server 202.

S104: The first CDN cache server 202 determines that the first network distance D1 is greater than the sum of the second network distance D2 and the third network distance D3.

The first network distance D1 can indicate a direct network distance from the first CDN cache server 202 to the source station 206, and the sum of the second network distance D2 and the third network distance D3 can indicate a network distance from the first CDN cache server 202 to the source station 206 through the second CDN cache server 204, that is, an indirect network distance from the first CDN cache server 202 to the source station 206.

Therefore, if the first network distance D1 is greater than the sum of the second network distance D2 and the third network distance D3, that is, D1>(D2+D3), it indicates that the indirect back-to-source has a smaller network distance and a faster back-to-source speed compared with the direct back-to-source.

S106: The first CDN cache server 202 generates back-to-source routing information and sends the back-to-source routing information to the second CDN cache server 204.

As it is determined in step S104 that the indirect back-to-source has a smaller network distance and a faster back-to-source speed compared with the direct back-to-source, the example embodiment of the present disclosure generates back-to-source routing information corresponding to the indirect back-to-source. Wherein, a back-to-source routing path indicated by the back-to-source routing information includes: passing through the first CDN cache server 202, the second CDN cache server 204 and the source station 206.

After generating the back-to-source routing information, the first CDN cache server 202 sends the back-to-source routing information to the second CDN cache server 204, and the second CDN cache server 204, after receiving the back-to-source routing information, may send the back-to-source routing information to the source station 206, so that the source station 206 returns a corresponding network resource according to the back-to-source routing information.

It can be known through the above technical solution that the example embodiment of the present disclosure is used in a back-to-source process of a CDN, and a first CDN cache server 202 no longer employs a direct back-to-source manner. Instead, when it is determined that a first network distance D1 is greater than the sum of a second network distance D2 and a third network distance D3, that is, a direct network distance between the first CDN cache server and a source station is greater than an indirect network distance (a network distance from the first CDN cache server 202 to the source station 206 through a second CDN cache server 204), indicating that a back-to-source routing path of indirect back-to-source is better than that of direct back-to-source, back-to-source routing information indicating the indirect back-to-source is generated, and the back-to-source routing information is sent to the second CDN cache server 204 to implement indirect back-to-source. It is thus clear that the example embodiment of the present disclosure can employ an indirect back-to-source route when determining, according to a network distance between the source station and the CDN cache server, that a back-to-source route of indirect back-to-source is better than that of direct back-to-source, thus increasing a back-to-source speed and reducing a back-to-source error rate.

In the example embodiment of the present disclosure, respective CDN cache servers in the CDN can detect, in real time, a direct network distance to a source station and a direct network distance to another CDN cache server, and synchronize, in real time, the network distance detected to the another CDN cache server. When the first CDN cache server needs to perform CDN back-to-source, a back-to-source routing path having the minimum network distance from the first CDN cache server to the source station is calculated, for example, the path passes through the first CDN cache server 202, the second CDN cache server 204 and the source station 206. The back-to-source routing information is generated according to the routing path.

When there are more CDN cache servers in the CDN, the amount of calculation when the first CDN cache server 202 calculates the back-to-source routing path may be relatively great. Therefore, the example embodiment of the present disclosure may be applied to a CDN having multiple levels of cache nodes, wherein the top-level cache node is used for acquiring a network resource directly from the source station 206, and other levels of cache nodes are used for acquiring a network resource directly from a node in an upper level. The first CDN cache server 202 and the second CDN cache server 204 both belong to the top-level cache node. In such a structure, only the CDN cache servers that belong to the top-level cache node need to detect network distances, and the first CDN cache server only needs to make calculation according to the network distances detected by the CDN cache servers that belong to the top-level cache node, such that the amount of calculation of the first CDN cache server can be reduced greatly. For example, if the CDN includes one hundred thousand CDN cache servers, wherein only ten thousand CDN cache servers are top-level cache servers, the first CDN cache server only needs to make calculation according to network distances detected by the ten thousand CDN cache servers, thus reducing the work load.

For example, a CDN has two levels of cache nodes. The CDN has first-level cache nodes and second-level cache nodes. Wherein, the first-level cache nodes, that is, L1 nodes, also referred to as access nodes, are used for acquiring network resources directly from the second-level cache nodes; the second-level cache nodes, that is, L2 nodes, also referred to as back-to-source nodes, are used for acquiring network resources directly from the source station; the first CDN cache server 202 and the second CDN cache server 204 both belong to the second-level cache nodes.

In the example embodiment of the present disclosure, the second CDN cache server 204 is directly or indirectly connected to the source station 206. The situation of indirect connection is specifically described in the following.

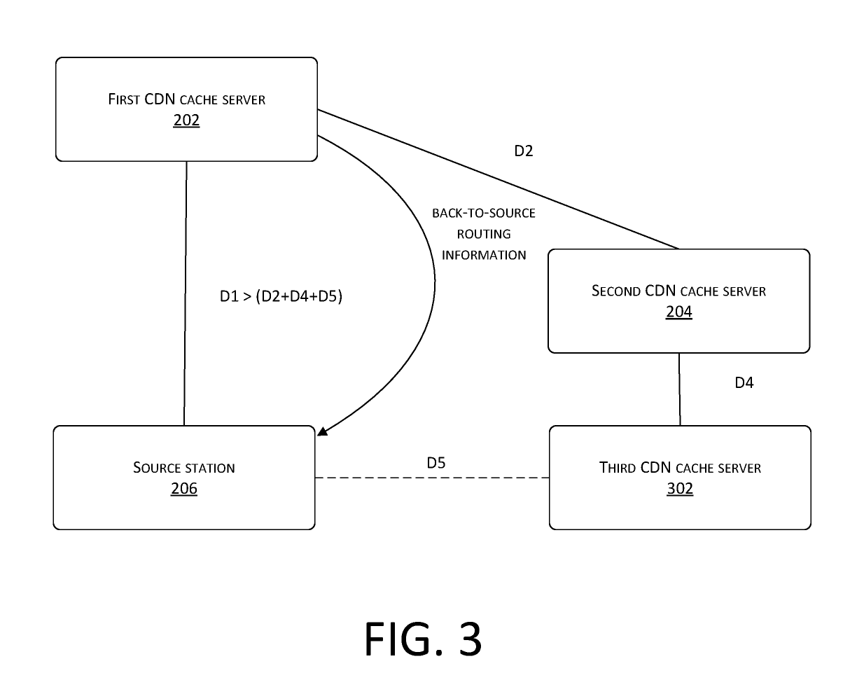

The third network distance D3 is an indirect network distance between the second CDN cache server 204 and the source station 206. For example, as shown in FIG. 3, the third network distance D3 is the sum of a fourth network distance D4 and a fifth network distance D5, that is, D3=D4+D5. The fourth network distance D4 is a direct network distance between the second CDN cache server 204 and a third CDN cache server 302, and the fifth network distance D5 is a direct or indirect network distance between the third CDN cache server 302 and the source station 206.

The back-to-source routing path indicated by the back-to-source routing information includes: passing through the first CDN cache server 202, the second CDN cache server 204, the third CDN cache server 302 and the source station 206.

A process of transmitting the back-to-source routing information after the second CDN cache server 204 receives the back-to-source routing information is specifically described in the following.

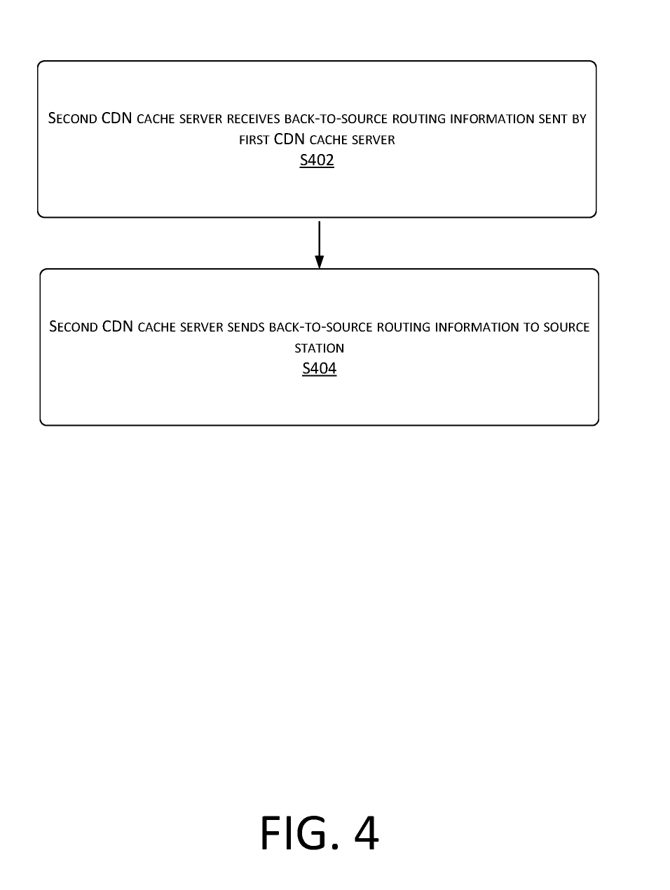

Referring to FIG. 4, an example embodiment of the present disclosure provides an example method embodiment of a back-to-source routing information transmission method.

A CDN of this example embodiment may, as shown in FIG. 2, include a first CDN cache server 202, a second CDN cache server 204 and a source station 206. Wherein, the first CDN cache server 202 is directly connected to the source station 206, the first CDN cache server 202 is directly connected to the second CDN cache server 204, and the second CDN cache server 204 is directly or indirectly connected to the source station 206. This example embodiment is applied to a back-to-source process of a CDN, that is, when the first CDN cache server 202 does not store a network resource requested by a user, at this point, the first CDN cache server 202 needs to acquire the network resource from the source station 206.

The transmission method of this example embodiment includes:

S402: The second CDN cache server 204 receives back-to-source routing information sent by the first CDN cache server 202, a back-to-source routing path indicated by the back-to-source routing information including: passing through the first CDN cache server 202, the second CDN cache server 204 and the source station 206.

S404: The second CDN cache server 204 sends the back-to-source routing information to the source station 206.

Wherein, the second CDN cache server 204 may directly send the back-to-source routing information to the source station 206, and may also indirectly send the back-to-source routing information to the source station 206 through another CDN cache server. A specific sending manner is determined by nodes included in the back-to-source routing information. The source station 206, after receiving the back-to-source routing information, returns a network resource according to a reverse direction of a path indicated by the back-to-source routing path.

In the example embodiment of the present disclosure, the first network distance D1 is greater than the sum of the second network distance D2 and the third network distance D3, that is, D1>(D2+D3). Wherein, the first network distance D1 is a direct network distance between the first CDN cache server 202 and the source station 206, the second network distance D2 is a direct network distance between the first CDN cache server 202 and the second CDN cache server 204, and the third network distance D3 is a direct or indirect network distance between the second CDN cache server 204 and the source station 206. D1>(D2+D3) indicates that the indirect back-to-source has a smaller network distance and a faster back-to-source speed compared with the direct back-to-source.

The example embodiment shown in FIG. 4 is corresponding to the example embodiment shown in FIG. 1, and reference can be made to the specific description of the example embodiment shown in FIG. 1 for related contents, which are not repeated here.

It can be known through the above technical solution that the example embodiment of the present disclosure is used in a back-to-source process of a CDN, and a first CDN cache server 202 no longer employs a direct back-to-source manner. Instead, when it is determined that a first network distance D1 is greater than the sum of a second network distance D2 and a third network distance D3, that is, a direct network distance between the first CDN cache server and a source station is greater than an indirect network distance (a network distance from the first CDN cache server 202 to the source station 206 through a second CDN cache server 204), indicating that a back-to-source routing path of indirect back-to-source is better than that of direct back-to-source, the second CDN cache server 204 receives back-to-source routing information indicating the indirect back-to-source and sends the back-to-source routing information to the source station 206 to implement indirect back-to-source. It is thus clear that the example embodiment of the present disclosure can employ an indirect back-to-source route when determining, according to a network distance between the source station and the CDN cache server, that a back-to-source route of indirect back-to-source is better than that of direct back-to-source, thus increasing a back-to-source speed and reducing a back-to-source error rate.

Wherein, the first network distance D1, the second network distance D2 or the third network distance D3 may be calculated according to any one or more of the following parameters: connection setup time, a physical transmission distance, a transmission bandwidth, and transmission quality.

In the example embodiment of the present disclosure, the second CDN cache server 204 can detect, in real time, the third network distance D3 from the second CDN cache server 204 to the source station 206. For example, the time when a connection is set up between the second CDN cache server 204 and the source station 206 is detected in real time, and the third network distance D3 is calculated according to the time. The detected third network distance D3 is then sent to the first CDN cache server 202.

Optionally, the example embodiment of the present disclosure is applied to a CDN having multiple levels of cache nodes, wherein the top-level cache node is used for acquiring a network resource directly from the source station 206. The first CDN cache server 202 and the second CDN cache server 204 both belong to the top-level cache node.

Optionally, the third network distance D3 is an indirect network distance between the second CDN cache server 204 and the source station 206. For example, as shown in FIG. 3, the third network distance D3 is the sum of a fourth network distance D4 and a fifth network distance D5, that is, D3=D4+D5. The fourth network distance D4 is a direct network distance between the second CDN cache server 204 and a third CDN cache server 302, and the fifth network distance D5 is a direct or indirect network distance between the third CDN cache server 302 and the source station 206. The back-to-source routing path indicated by the back-to-source routing information includes: passing through the first CDN cache server 202, the second CDN cache server 204, the third CDN cache server 302 and the source station 206. In step S404, the second CDN cache server 204 sends the back-to-source routing information to the source station 206 through the third CDN cache server 302.

A specific example embodiment of a back-to-source routing information generation and transmission method is provided in the following.

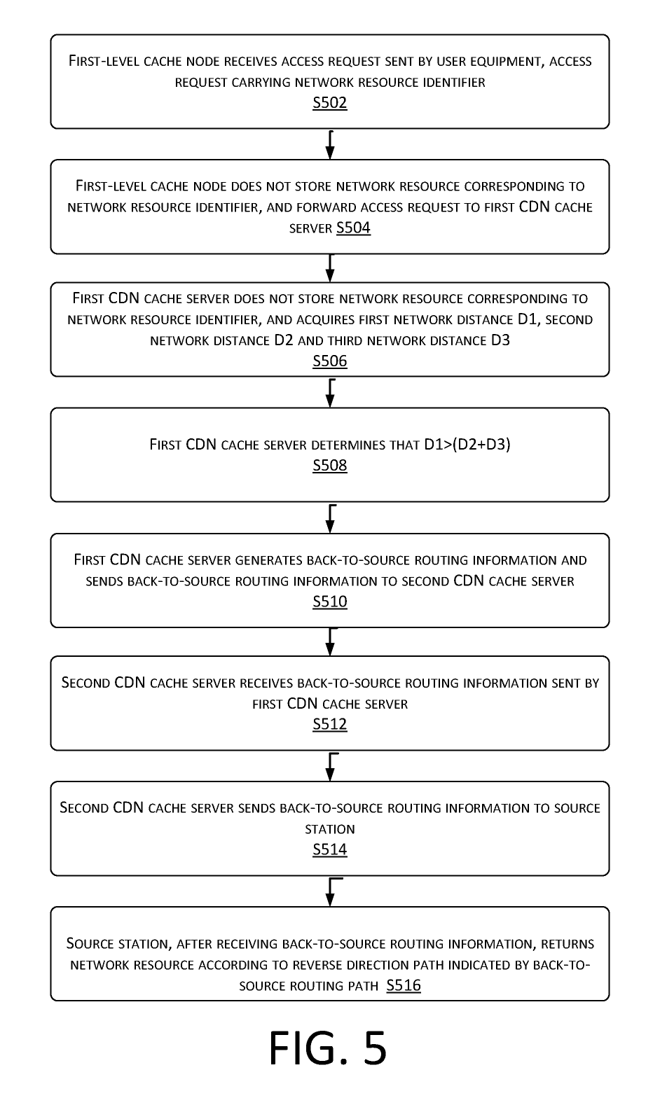

Referring to FIG. 5, an example embodiment of the present disclosure provides another example method embodiment of a back-to-source routing information generation and transmission method.

This example embodiment is applied to a CDN shown in FIG. 2, the CDN having first-level cache nodes (not shown) and second-level cache nodes, and the first CDN cache server 202 and the second CDN cache server 204 both belong to the second-level cache nodes. The first CDN cache server 202 is directly connected to the source station 206, the first CDN cache server 202 is directly connected to the second CDN cache server 204, and the second CDN cache server 204 is directly connected to the source station 206.

Each second-level cache nodes in the CDN detects, in real time, a direct network distance to the source station 206 and a direct network distance to another second-level cache node, and synchronizes the network distances detected in real time into the another second-level cache node.

The method of this example embodiment includes:

S502: The first-level cache node (not shown in FIG. 2) receives an access request sent by a user equipment (not shown in FIG. 2), the access request carrying a network resource identifier.

S504: The first-level cache node does not store a network resource corresponding to the network resource identifier, and forwards the access request to the first CDN cache server 202.

S506: The first CDN cache server 202 does not store a network resource corresponding to the network resource identifier, and acquires a first network distance D1, a second network distance D2 and a third network distance D3.

Wherein, the first network distance D1 and the second network distance D2 are detected in real time by the first CDN cache server 202, and the third network distance D3 is detected in real time by the second CDN cache server 204 and sent to the first CDN cache server 202.

S508: The first CDN cache server 202 determines that D1>(D2+D3).

S510: The first CDN cache server 202 generates back-to-source routing information and sends the back-to-source routing information to the second CDN cache server 204. A back-to-source routing path indicated by the back-to-source routing information includes: sequentially passing through the first CDN cache server 202, the second CDN cache server 204 and the source station 206.

If the first CDN cache server 202 determines that D1<(D2+D3), the back-to-source routing path indicated by the back-to-source routing information includes: sequentially passing through the first CDN cache server 202 and the source station 206.

S512: The second CDN cache server 204 receives the back-to-source routing information sent by the first CDN cache server 202.

S514: The second CDN cache server 204 sends the back-to-source routing information to the source station 206.

S516: The source station 206, after receiving the back-to-source routing information, returns a network resource according to a reverse direction of a path indicated by the back-to-source routing path.

Corresponding to the above example method embodiment, the present disclosure further provides example apparatus embodiments of the corresponding CDN cache servers and an example system embodiment of a CDN system, which are specifically described in the following.

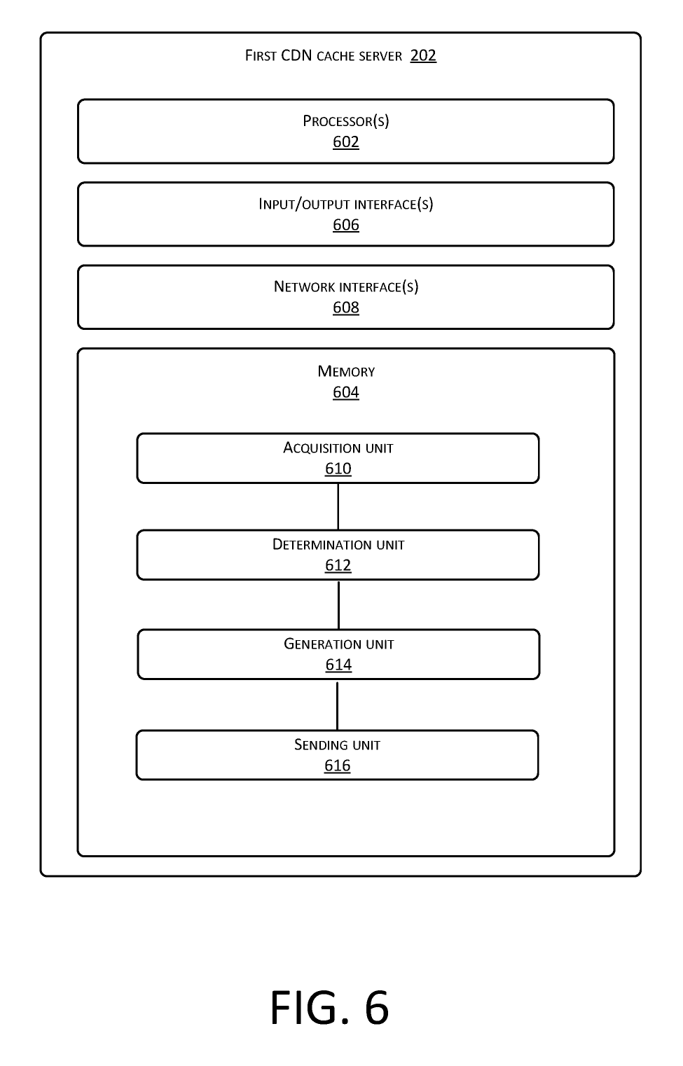

Referring to FIG. 6, an example embodiment of the present disclosure provides an example apparatus embodiment of a first CDN cache server 202. The first CDN cache server 202 includes one or more processor(s) 602 or data processing unit(s) and memory 604. The first CDN cache server 202 may further include one or more input/output interface(s) 606, and network interface(s) 608. The memory 604 is an example of computer readable media.

The computer readable media include volatile and non-volatile, removable and non-removable media, and can use any method or technology to store information. The information may be a computer readable instruction, a data structure, and a module of a program or other data. Examples of storage media of a computer include, but are not limited to, a phase change memory (PRAM), a static random access memory (SRAM), a dynamic random access memory (DRAM), other types of RAMs, an ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be that storing information accessible to a computation device. According to the definition herein, the computer readable media does not include transitory computer readable media (transitory media), for example, a modulated data signal and a carrier.

The memory 604 may store therein a plurality of modules or units including an acquisition unit 610, a determination unit 612, a generation unit 614 and a sending unit 616.

A CDN of this example embodiment may, as shown in FIG. 2, include a first CDN cache server 202, a second CDN cache server 204 and a source station 206. Wherein, the first CDN cache server 202 is directly connected to the source station 206, the first CDN cache server 202 is directly connected to the second CDN cache server 204, and the second CDN cache server 204 is directly or indirectly connected to the source station 206.

This example embodiment is applied to a back-to-source process of the CDN, that is, when the first CDN cache server 202 does not store a network resource requested by a user, at this point, the first CDN cache server 202 needs to acquire the network resource from the source station 206.

The acquisition unit 610 is configured to acquire a first network distance, a second network distance and a third network distance.

Wherein, the first network distance D1 is a direct network distance between the first CDN cache server 202 and the source station 206, the second network distance D2 is a direct network distance between the first CDN cache server 202 and the second CDN cache server 204, and the third network distance D3 is a direct or indirect network distance between the second CDN cache server 204 and the source station 206.

In the example embodiment of the present disclosure, the network distance is used for reflecting a network transmission speed of two nodes, and a smaller network distance indicates a faster network transmission speed. Wherein, the first network distance D1, the second network distance D2 or the third network distance D3 may be calculated according to any one or more of the following parameters: connection setup time, a physical transmission distance, a transmission bandwidth, and transmission quality.

In the example embodiment of the present disclosure, the acquisition unit 610 may detect, in real time, the first network distance D1 between the first CDN cache server 202 and the second CDN cache server 204, and the second network distance D2 between the first CDN cache server 202 and the source station 206. For example, the time when a connection is set up between the first CDN cache server 202 and the second CDN cache server 204 is detected in real time, and the first network distance D1 is calculated according to the time. The second CDN cache server 204 may also detect, in real time, the third network distance D3 from the second CDN cache server 204 to the source station 206, and send the detected third network distance D3 to the first CDN cache server 202.

The determination unit 612 is configured to determine that the first network distance is greater than the sum of the second network distance and the third network distance.

The first network distance D1 can indicate a direct network distance from the first CDN cache server 202 to the source station 206. The sum of the second network distance D2 and the third network distance D3 can indicate a network distance from the first CDN cache server 202 to the source station 206 through the second CDN cache server 204, that is, an indirect network distance from the first CDN cache server 202 to the source station 206.

Therefore, if the first network distance D1 is greater than the sum of the second network distance D2 and the third network distance D3, that is, D1>(D2+D3), it indicates that the indirect back-to-source has a smaller network distance and a faster back-to-source speed compared with the direct back-to-source.

The generation unit 614 is configured to generate back-to-source routing information after the determination unit 612 determines that the first network distance is greater than the sum of the second network distance and the third network distance.

As the determination unit 612 determines that the indirect back-to-source has a smaller network distance and a faster back-to-source speed compared with the direct back-to-source, the generation unit 614 generates back-to-source routing information corresponding to the indirect back-to-source. Wherein a back-to-source routing path indicated by the back-to-source routing information includes: passing through the first CDN cache server 202, the second CDN cache server 204 and the source station 206.

The sending unit 616 is configured to send the back-to-source routing information to the second CDN cache server; a back-to-source routing path indicated by the back-to-source routing information including: passing through the first CDN cache server, the second CDN cache server and the source station.

After the generation unit 614 generates the back-to-source routing information, the sending unit 616 sends the back-to-source routing information to the second CDN cache server 204, and the second CDN cache server 204, after receiving the back-to-source routing information, may send the back-to-source routing information to the source station 206, so that the source station 206 returns a corresponding network resource according to the back-to-source routing information.

Optionally, the acquisition unit 610 includes: a detection sub-unit configured to detect the first network distance and the second network distance; and an acquisition sub-unit configured to acquire the third network distance sent by the second CDN cache server.

Optionally, a CDN has multiple levels of cache nodes, wherein the top-level cache node is used for acquiring network resources directly from the source station; and the first CDN cache server and the second CDN cache server both belong to the top-level cache node.

Optionally, the third network distance is an indirect network distance between the second CDN cache server and the source station, the third network distance is the sum of a fourth network distance and a fifth network distance, the fourth network distance is a direct network distance between the second CDN cache server and a third CDN cache server, and the fifth network distance is a direct or indirect network distance between the third CDN cache server and the source station; and the back-to-source routing path indicated by the back-to-source routing information including: passing through the first CDN cache server, the second CDN cache server, the third CDN cache server and the source station.

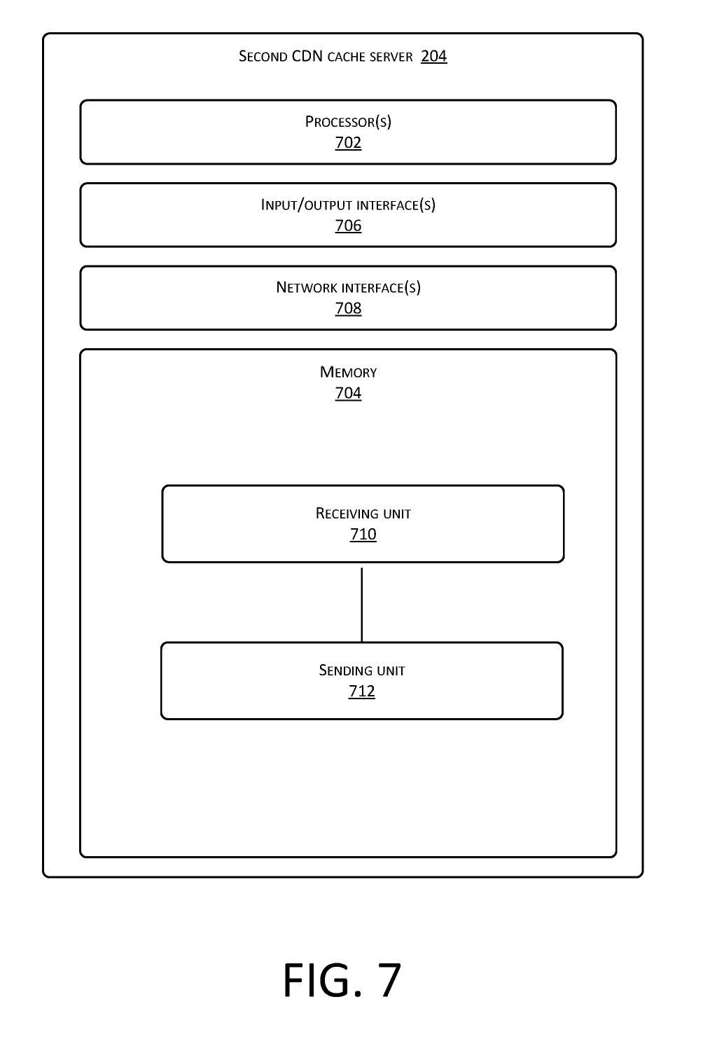

Referring to FIG. 7, an example embodiment of the present disclosure provides an example apparatus embodiment of a second CDN cache server 204. The second CDN cache server 204 includes one or more processor(s) 702 or data processing unit(s) and memory 704. The second first CDN cache server 204 may further include one or more input/output interface(s) 706, and network interface(s) 708. The memory 704 is an example of computer readable media.

The memory 704 may store therein a plurality of modules or units including a receiving unit 710 and a sending unit 712.

A CDN of this example embodiment may, as shown in FIG. 2, include a first CDN cache server 202, a second CDN cache server 204 and a source station 206. Wherein, the first CDN cache server 202 is directly connected to the source station 206, the first CDN cache server 202 is directly connected to the second CDN cache server 204, and the second CDN cache server 204 is directly or indirectly connected to the source station 206. This example embodiment is applied to a back-to-source process of a CDN, that is, when the first CDN cache server 202 does not store a network resource requested by a user, at this point, the first CDN cache server 202 needs to acquire the network resource from the source station 206.

The receiving unit 710 is configured to receive back-to-source routing information sent by the first CDN cache server, a back-to-source routing path indicated by the back-to-source routing information including: passing through the first CDN cache server 202, the second CDN cache server 204 and the source station 206.

The sending unit 712 is configured to send the back-to-source routing information to the source station.

Wherein, the sending unit 712 may directly send the back-to-source routing information to the source station 206, and may also indirectly send the back-to-source routing information to the source station 206 through another CDN cache server. A specific sending manner is determined by nodes included in the back-to-source routing information. The source station 206, after receiving the back-to-source routing information, returns a network resource according to a reverse direction of a path indicated by the back-to-source routing path.

In the example embodiment of the present disclosure, the first network distance D1 is greater than the sum of the second network distance D2 and the third network distance D3, that is, D1>(D2+D3). Wherein, the first network distance D1 is a direct network distance between the first CDN cache server 202 and the source station 206, the second network distance D2 is a direct network distance between the first CDN cache server 202 and the second CDN cache server 204, and the third network distance D3 is a direct or indirect network distance between the second CDN cache server 204 and the source station 206. D1>(D2+D3) indicates that the indirect back-to-source has a smaller network distance and a faster back-to-source speed compared with the direct back-to-source.

Optionally, the second CDN cache server 204 further includes: a detection unit configured to detect the third network distance by the second CDN cache server; and the sending unit 712 is further configured to send the detected third network distance to the first CDN cache server.

Optionally, a CDN has multiple levels of cache nodes, wherein the top-level cache node is used for acquiring network resources directly from the source station; and the first CDN cache server and the second CDN cache server both belong to the top-level cache node.

Optionally, the third network distance is an indirect network distance between the second CDN cache server and the source station, the third network distance is the sum of a fourth network distance and a fifth network distance, the fourth network distance is a direct network distance between the second CDN cache server and a third CDN cache server, and the fifth network distance is a direct or indirect network distance between the third CDN cache server and the source station; the back-to-source routing path indicated by the back-to-source routing information including: passing through the first CDN cache server, the second CDN cache server, the third CDN cache server and the source station. The sending unit 712 is specifically configured to send the back-to-source routing information to the source station through the third CDN cache server.

Optionally, the first network distance, the second network distance or the third network distance is calculated according to any one or more of the following parameters: connection setup time, a physical transmission distance, a transmission bandwidth, and transmission quality.

Referring to FIG. 2, the present disclosure further provides an example system embodiment of a CDN system. The CDN system of this example embodiment includes a first CDN cache server 202, a second CDN cache server 204 and a source station 206.

The first CDN cache server 202 is configured to acquire a first network distance D1, a second network distance D2 and a third network distance D3, determine that the first network distance D1 is greater than the sum of the second network distance D2 and the third network distance D3, generate back-to-source routing information, and send the back-to-source routing information to the second CDN cache server 204.

Wherein, the first network distance D1 is a direct network distance between the first CDN cache server 202 and the source station 206, the second network distance D2 is a direct network distance between the first CDN cache server 202 and the second CDN cache server 204, and the third network distance D3 is a direct or indirect network distance between the second CDN cache server 204 and the source station 206.

A back-to-source routing path indicated by the back-to-source routing information includes: passing through the first CDN cache server 202, the second CDN cache server 204 and the source station 206.

The second CDN cache server 204 is configured to receive the back-to-source routing information sent by the first CDN cache server 202, and send the back-to-source routing information to the source station 206.

The source station 206 is configured to receive the back-to-source routing information sent by the second CDN cache server 204, and return a network resource according to a reverse direction of a path indicated by the back-to-source routing path.

Those skilled in the art can understand that, for ease and clarity of description, specific working processes of the system, the apparatus and the units described in the above may be obtained with reference to the corresponding processes in the foregoing example method embodiments, and are not repeated herein.

In the several example embodiments provided in the present disclosure, it should be understood that the disclosed system, apparatus and method may be implemented in other manners. For example, the example apparatus embodiment described in the foregoing is merely illustrative. For instance, the division of units may be merely division of logic functions, and in fact, there may be other division manners during implementation. For example, multiple units or components may be combined or may be integrated into another system, or some features may be omitted or not be executed. On the other hand, the displayed or discussed coupling or direct coupling or communication connection between them may be implemented through indirect coupling or communication connection between some interfaces, apparatuses or units, and may be in the form of electrical, mechanical or other forms.

Units described as separated parts may be or may not be physically separated, parts displayed as units may be or may not be physical units, and they may be located at the same place, or be distributed to multiple network units. The objective of the solution of this example embodiment may be implemented by selecting a part of or all units thereof according to actual requirements.

In addition, functional units in the example embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part that makes contributions to the prior art, or all or a part of the technical solutions may be implemented in a form of a software product. The computer software product is stored in a storage medium, and includes several instructions for instructing a computer device (which may be a personal computer, a server, a network device or the like) to perform all or a part of the steps of the methods described in the example embodiments of the present disclosure. The foregoing storage medium includes: any medium that can store a program code, such as a USB flash drive, a removable hard disk, a Read-Only Memory (ROM), a Random Access Memory (RAM), a magnetic disk, or an optical disc.

In summary, the above example embodiments are merely provided for describing the technical solutions of the present disclosure, but not intended to limit the present disclosure. It should be understood by those of ordinary skill in the art that although the present disclosure has been described in detail with reference to the foregoing example embodiments, modifications can be made to the technical solutions described in the foregoing example embodiments, or equivalent replacements can be made to some technical features in the technical solutions, as long as such modifications or replacements do not cause the essence of corresponding technical solutions to depart from the spirit and scope of the technical solutions of the example embodiments of the present disclosure.

What is claimed is:

1. A method comprising:
acquiring, by a first Content Delivery Network (CDN) cache server, a first network distance, a second network distance and a third network distance, the first network distance being a direct network distance between the first CDN cache server and a source station, the second network distance being a direct network distance between the first CDN cache server and a second CDN cache server, and the third network distance being a direct network distance between the second CDN cache server and the source station or an indirect network distance between the second CDN cache server and the source station;
determining that the first network distance is greater than a sum of the second network distance and the third network distance; and
generating back-to-source routing information that indicates a back-to-source routing path including passing through the first CDN cache server, the second CDN cache server, and the source station.

2. The method of claim 1, further comprising sending the back-to-source routing information to the second CDN cache server

3. The method of claim 1, wherein the acquiring the first network distance and the second network distance includes:
detecting the first network distance and the second network distance; and
acquiring the third network distance.

4. The method of claim 3, wherein the acquiring the third network distance includes acquiring the third network distance sent by the second CDN cache server.

5. The method of claim 1, wherein:
the CDN has multiple levels of cache nodes, a top-level cache node of the multiple levels of cache nodes being used for acquiring network resources directly from the source station; and
the first CDN cache server and the second CDN cache server are the top-level cache node.

6. The method of claim 1, wherein:
the third network distance is an indirect network distance between the second CDN cache server and the source station, the third network distance being a sum of a fourth network distance and a fifth network distance, the fourth network distance being a direct network distance between the second CDN cache server and a third CDN cache server, and the fifth network distance being a direct or indirect network distance between the third CDN cache server and the source station; and
the back-to-source routing path indicated by the back-to-source routing information includes passing through the first CDN cache server, the second CDN cache server, the third CDN cache server and the source station.

7. The method of claim 1, further comprising calculating the first network distance, the second network distance or the third network distance at least partly based on a connection setup time.

8. The method of claim 1, further comprising calculating the first network distance, the second network distance or the third network distance at least partly based on a physical transmission distance.

9. The method of claim 1, further comprising calculating the first network distance, the second network distance or the third network distance at least partly based on a transmission bandwidth.

10. The method of claim 1, further comprising calculating the first network distance, the second network distance or the third network distance at least partly based on a transmission quality.

11. A method comprising:
receiving, by a second Content Delivery Network (CDN) cache server, back-to-source routing information sent by a first CDN cache server, a back-to-source routing path indicated by the back-to-source routing information including passing through the first CDN cache server, the second CDN cache server and a source station; and
sending, by the second CDN cache server, the back-to-source routing information to the source station,
wherein:
a first network distance is greater than a sum of a second network distance and a third network distance;
the first network distance is a direct network distance between the first CDN cache server and the source station;
the second network distance is a direct network distance between the first CDN cache server and the second CDN cache server; and
the third network distance is a direct network distance between the second CDN cache server and the source station or an indirect network distance between the second CDN cache server and the source station.

12. The method of claim 11, further comprising:
before receiving the back-to-source routing information,
detecting the third network distance; and
sending the detected third network distance to the first CDN cache server.

13. The method of claim 11, wherein:
the CDN has multiple levels of cache nodes, a top-level cache node of the multiple levels of cache nodes being used for acquiring network resources directly from the source station; and
the first CDN cache server and the second CDN cache server are the top-level cache node.

14. The method of claim 11, wherein:
the third network distance is an indirect network distance between the second CDN cache server and the source station, the third network distance being a sum of a fourth network distance and a fifth network distance, the fourth network distance being a direct network distance between the second CDN cache server and a third CDN cache server, and the fifth network distance being a direct or indirect network distance between the third CDN cache server and the source station; and
the back-to-source routing path indicated by the back-to-source routing information includes passing through the first CDN cache server, the second CDN cache server, the third CDN cache server and the source station.

15. The method of claim 14, wherein the sending the back-to-source routing information to the source station includes sending the back-to-source routing information to the source station through the third CDN cache server.

16. The method of claim 11, wherein the first network distance, the second network distance or the third network distance is calculated according to any one or more of the following parameters including:
a connection setup time;
a physical transmission distance;
a transmission bandwidth; and
a transmission quality.

17. A system comprising:
a first Content Delivery Network (CDN) cache server that:
acquires a first network distance, a second network distance and a third network distance, the first network distance being a direct network distance between the first CDN cache server and a source station, the second network distance being a direct network distance between the first CDN cache server and a second CDN cache server, and the third network distance being a direct network distance between the second CDN cache server and the source station or an indirect network distance between the second CDN cache server and the source station;
determines that the first network distance is greater than a sum of the second network distance and the third network distance; and
generates back-to-source routing information that indicates a back-to-source routing path including passing through the first CDN cache server, the second CDN cache server, and the source station.

18. The system of claim 17, wherein the first CDN cache server further sends the back-to-source routing information to the second CDN cache server

19. The system of claim 17, further comprising the second CDN cache server that:
receive the back-to-source routing information sent by the first CDN cache server; and
send the back-to-source routing information to the source station.

20. The system of claim 17, further comprising the source station that:
receives the back-to-source routing information sent by the second CDN cache server; and
returns a network resource according to a reverse direction of a path indicated by the back-to-source routing path.
